(19) United States
(12) Patent Application Publication
(10) Pub. No.: US 2005/0062274 A1
(43) Pub. Date: Mar. 24, 2005

(54) Inflatable airbag spinal protector for paraglider pilots

(76) Inventor: Brett Stewart Snellgrove, Makawao, HI (US)

Correspondence Address: BRETT STEWART SNELLGROVE;STE 22, 81 MAKAWAO AVE, MAKAWAO, HI, 96768, US

(21) Appl. No.: 10/664,742

(22) Filed: Sep. 18, 2003

(51) Int. Cl. B60R 21/16

(52) U.S. Cl. 280/743.1

(57) ABSTRACT

An inflatable airbag (by mouth or mechanical pump) that remains continuously inflated and deployed for use in situations where complex impact detection sensors and gas generator inflation, deployment devices are not practical or desirable. It is anticipated this device will have most suitable application in the protection of the vulnerable spinal regions of participants in foot launched and ultralight aviation, in particular paraglider pilots. Participants in this aviation sport suffer from an unacceptably high incidence of vertebral fracture, spinal injury and paralysis due to the semi-reclined, seated position adopted in flight, and in utilizing aircraft subject to turbulence induced deflation and collapse at low altitude with resulting ground impact. This device when fashioned into an aerodynamic, L shaped curve and positioned in the rear of the flying harness, covers and protects the upper thigh, buttock, lumbar, thoracic and cervical spine from dorsal impacts.

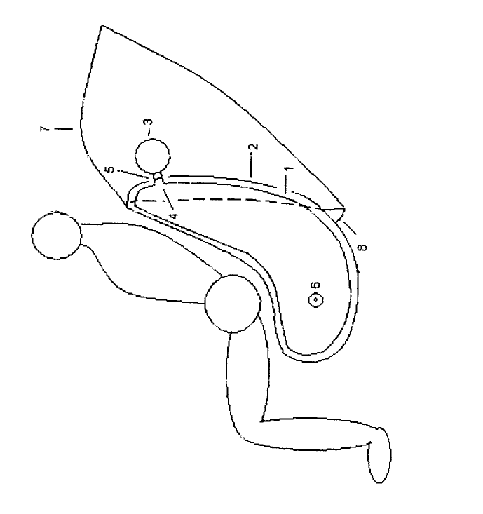

### BACKGROUND OF THE INVENTION

There are two types of airbag back protector systems currently used for the purpose of protection of spinal regions of paraglider pilots. Type 1 is the ram or wind inflated airbag designed by Oliver Meyer referenced in foreign patents (2). Type 2 is the foam filled airbag designed by Helmut Hinter referenced in foreign patents (1). This inflatable airbag device overcomes the inherent limitations of both designs.

Type 1, ram or wind inflated airbags utilize forward airspeed to ram inflate a fabric airbag through a frontal, one way vent in a single layered bag in a manner similar to a windsock. These bags do not use a specific, adjustable vent and rather, permit air venting through air permeable seam holes left following sewing which can not be adjusted to provide optimal protection in a variety of pilot weights.

The forward airspeed of paragliders is significantly limited, severely restricting inflation pressure, as such large intake valves, (with large, drag producing frontal sectional area) are required and internal air pressure is low, only marginally above atmospheric. Furthermore as a result of this low internal pressure, internal partitions are required in an effort to restrain air under the impacted region and prevent air moving into other regions of the bag other than through the vents. This is only marginally successful and, upon impact, such airbag designs require 50% of the total available thickness to pressurize internal air sufficiently to provide adequate impact resistance.

A ram airbag of 30 cms thickness will not provide sufficient impact resistance until the pilot has fallen 15 cms into the bag. Testing of ram airbags carried out by the FFVL (Federation Francaise de Vol Libre) (1) in their review of the Cygnus airbag found the following, “it is clear that half the brake distance (about 15 cm) is not good enough with the dummy tumbling over” and “video shows that the first 15 cm of impact are useless in shock absorbing”.

Parasitic drag is a significant factor in the performance of paragliders and other ultralight aircraft and the thickness of protection systems is severely restricted by drag considerations. Increasing the thickness of ram airbags to establish an adequate, functional airbag thickness is not practical in a design that is only 50% efficient. Furthermore, at launch when forward speed is low, these bags remain deflated and as such provide no impact protection at a time when most accidents occur.

While ram air inflation was considered satisfactory to inflate the aerodynamic cowling portion of this design, it is not considered adequate for the functional, spinal protection component.

Type 2 foam airbags utilize soft, internal, synthetic, foam rubbers to hold the airbag open at all times. Venting on impact is through the stitched seams or semi-permeable fabric. Such airbags are fully open and inflated at launch overcoming a principle limitation of ram air inflated bags. However, the internal air pressure remains at atmospheric and such these airbags require multiple, internal partitions in an effort to retain the internal air in the impacted region under the pilot. Due to low internal air pressure and volume, at least 15% of the available thickness is required to pressurize the internal air before impact resistance occurs. Furthermore, the foam has considerable bulk, as such these airbags are difficult to fold or compress sufficiently to permit containment in the typical backpack utilized to transport paragliding equipment. Subsequently, these foam bags are typically limited to a thickness of not more than 21 cms, and most commonly 17 cms.

### BRIEF SUMMARY OF THE INVENTION

Effective deceleration distance is the critical factor in dissipating impact velocity and preventing injury. Previously, effective deceleration distances of more than 17 cms have not been possible due to the functional and parasitic drag limitations of ram airbags, and portability restraints of foam airbags.

Due to the exceptionally low wing loading of paraglider wings, relatively low impact velocities occur in the event of most accidents. It has been calculated that an effective deceleration distance of 45 cms will mitigate up to 80% of dorsal impact injuries. The current, effective deceleration distance of 17 cm is inadequate to prevent the majority of injuries.

This inflatable airbag with expandable, balloon slave chamber, makes an airbag with effective deceleration distances of 45 cms and greater, possible, practical, easily transported and without excessive bulk or aerodynamic drag. It is anticipated this airbag will be more than two times as effective as current spinal protectors and as such will significantly reduce spinal injuries that continue to occur with current protection devices.

### DETAILED DESCRIPTION OF THE INVENTION

As shown in drawing 1, the device consists of a two layered airbag and an external, expandable rubber balloon slave chamber. The inner bladder (1) is constructed of impermeable; PVC plastic, RF welded at the seams. The outer fabric bag (2) is constructed of Dacron fabric which completely surrounds, restrains and protects the inner PVC bladder. The expandable, balloon, slave chamber (3) communicates with the inner bladder through a circular vent in the inner bladder to which it is firmly attached (4) a reinforced hole in the outer fabric bag (5) permits passage of the circular vent through the fabric bag, communication of the inner bladder with the balloon slave chamber, and externalization of the balloon slave chamber for unrestricted expansion.

Inflation of the inner bladder is permitted through a single inflation, deflation valve port in the inner bladder (6) which is externally accessed through an opening in the outer fabric bag in the same manner as the balloon slave chamber. The opening is surrounded by a rubber, ring seal which, in conjunction with the externalization of the circular vent, services to firmly fix the inner layer bladder to the wall of the outer fabric housing, preventing displacement on inflation and deflation.

An optional, aerodynamic cowling (7), attaches to mid to upper, posterior portion of the fabric housing to surround, and protect the expandable balloon slave chamber. The cowling is of sufficient internal volume to permit full expansion of the slave chamber on impact or increasing altitude. This cowling is ram air inflated in a similar manner to a windsock, by airflow generated from forward speed, passing through a semi circular duct opening under the airbag (8). The cowling is positioned such as to streamline the airflow behind the occupant's torso and fill the spaces between the circular, balloon slave chamber on full expansion to further reduce parasitic drag. It is not however an essential, functional component of spinal protection.

The airbag is constructed to fashion an L shaped curve to assume the shape of the spinal curvature in the recumbent position adopted in the harness during flight in a paraglider. The airbag extends from the mid thigh, covering the buttocks, lumbar and thoracic spine and attaches to existing paraglider harnesses by a system of Velcro straps or as a component in a purpose built harness and airbag combination.

1. An inflatable airbag spinal protector system comprising:
A gas impermeable inner bladder constructed of 2 sheets of PVC sheet plastic, or similar material, radio frequency welded at the edges such that upon inflation, fashions an aerodynamic, L shaped curve adapted to the thigh, lumbar, thoracic and cervical regions. The inner bladder incorporates a circular vent in the upper, posterior region consisting of a ring of PVC tubing of variable diameter, to permit controlled gas venting upon impact, and a separate inflation, deflation valve port in the lower lateral region.
An expandable, cylindrical, balloon slave chamber, constructed of synthetic rubber or similar material, which connects to the inner layer by attaching to the circular vent.
An outer, fabric bag comprised of sewn Dacron that services to surround, constrain and protect the inner bladder and including a reinforced hole in the upper, posterior region to permit external passage of the circular vent for external attachment of the balloon slave chamber.
An optional, ram air inflated, aerodynamic cowling constructed of Dacron fabric and attached to the mid to upper, posterior portion of the outer fabric bag, which surrounds and protects the balloon slave chamber, and is of sufficient size to permit full, unrestricted expansion of the balloon slave chamber. The cowling is shaped such, that when inflated, imparts aerodynamic streamlining and drag reduction, enhancing gliding performance. The cowling incorporates a semicircular opening in the undersurface of the airbag to allow air entry and cowling inflation with forward speed of the glider after the manner of a wind sock.

2. An airbag spinal protector system in accordance with claim 1, wherein the airbag is inflated prior to use through a single valve inlet, by mechanical pump or mouth, and remains inflated and deployed throughout use. Deflation after use allows small packing volume and easy transport.

3. An inflatable airbag spinal protector in accordance with claim 1, wherein the concomitant use of an expandable, rubber balloon, slave chamber allows air to vent from the internal bladder into the expanding balloon slave chamber, absorbing impact energy in venting the air and expanding the rubber chamber, thus imparting continuous and immediate impact resistance. Internal air compression and elastic recoil off a sealed, inflated chamber is thus avoided, and external air escape and loss of internal air volume at inappropriate times, prevented (as occurs with pressure triggered, dump valves during air density changes with altitude).

4. An airbag spinal protector in accordance with claim 3, wherein the concomitant use of an expandable, balloon slave chamber permits maintenance of internal air pressure at a significant level above ambient, atmospheric pressure. On impact this prevents air displacement to other regions of the bag as occurs in non-pressurized systems, and forces displaced air to exit primarily through the external vent wherein impact energy is absorbed. This renders the use of multiple chambers and internal partitions redundant, maximizes internal volume, imparts instantaneous impact absorption, and provides optimal impact resistance throughout airbag thickness thus preventing occupant free fall into the bag for any portion of its thickness.

5. An airbag spinal protector in accordance with claim 3, wherein the concomitant use of an expandable balloon slave chamber compensates for changes in air density and pressure with rising or descending altitude to maintain a high, effective, internal pressure independent of external, air density.

6. An airbag spinal protector in accordance with claim 1 wherein the use of a ram air inflated, streamlined, aerodynamic cowling provides a separate, non-pressurized chamber in which the balloon, slave chamber can fully expand without restriction or imparting additional aerodynamic drag and performance degradation.
